(19) United States
(12) Patent Application Publication
(10) Pub. No.: US 2025/0279013 A1
(43) Pub. Date: Sep. 4, 2025

(54) TRAINING MODEL FOR MEDICAL APPLICATIONS

(71) Applicant: The Research Foundation for The State University of New York, Albany, NY (US)

(72) Inventors: Patricia MELE, Mattituck, NY (US); Sean CAVANAUGH, Ronkonkoma, NY (US)

(73) Assignee: The Research Foundation for The State University of New York, Albany, NY (US)

(21) Appl. No.: 19/048,120

(22) Filed: Feb. 7, 2025

Related U.S. Application Data
(63) Continuation of application No. 16/340,253, filed on Apr. 8, 2019, now abandoned.
(60) Provisional application No. 62/410,163, filed on Oct. 19, 2016.
(60) Provisional application No. 62/519,610, filed on Jun. 14, 2017.

(51) Int. Cl. G09B 23/28; G09B 23/32; G09B 23/34

(52) U.S. Cl. CPC G09B 23/281; G09B 23/32; G09B 23/34

(57) ABSTRACT

The present disclosure is directed to an anatomical model and methods for using the same. The anatomical model of the present disclosure includes a plurality of simulated bodily structures that emulate the naturally occurring structures (e.g., organs, bones, and tissue) of the human body. The anatomical model of the present disclosure can be used to simulate clinical conditions observed in infant subjects and carry out medical procedures and interventions commonly practiced by clinicians under real-life conditions.

### CROSS-REFERENCE TO RELATED APPLICATIONS

This application is a Continuation Application of U.S. Ser. No. 16/340,253 filed Apr. 8, 2019, which is a national phase application of International Patent Application No. PCT/US2017/057101 filed on Oct. 18, 2017, which claims benefit of priority to U.S. Provisional Applications 62/410,163 filed on Oct. 19, 2016 and 62/519,610 filed on Jun. 14, 2017, the contents of both of which are incorporated by reference.

### BACKGROUND OF THE DISCLOSURE

Over the past two decades, the Accreditation Council for Graduate Medical Education (ACGME) has been steadily limiting trainees' work hours, specifying the frequency of overnight calls, consecutive hours a trainee can work and necessary time off. Individual providers' ability to perform in clinical situations, and patient outcomes, have been shown to be negatively impacted by sleep deprivation. The ACGME reform has transformed medical education in a way that has restricted opportunities to learn and achieve competence in the clinical field. The new generation of physicians exhibit essential scientific knowledge, but have limited exposure to critical clinical situations.

Simulation has long been used and proven effective in the aviation and nuclear power industries, and has been used more recently in medicine. The simulation method of teaching has become an integral part of educational curricula in medical fields to improve technical proficiencies and decrease medical errors. Southgate W M and Annibale D J, Adv Neonatal Care. 2010; 10(5):261-268; Cates L A, Wilson D, Adv Neonatal Care. 2011; 11(5):321-327. However, existing training models and methods lack many essential elements, and thus make it impossible to adequately train medical professionals to successfully conduct medical procedures on a subject. For example, existing training modes are not capable of stimulating the removal of gas and fluid from a subject and do not contain anatomically correct and operable simulated organs or structures. See Gupta AO, Ramasethu J. Pediatrics. 2014. 134 (3) e798-e805.

The neonatal population, both term and preterm, presents challenges with the need for technical precision due to the patients' unpredictability and small size. Gozzo Y, Mercurio M R, NeoReviews. 2009; 10(2):e82-e88. Thoracostomy tube insertion is a procedure that is widely used in critical care areas. Kesieme E B, et al. Pulmonary Medicine. 2012. Thoracostomy is a procedure for draining air and/or fluid from the chest of a subject. Pneumothorax occurs most commonly in the newborn period and is often an emergent and life saving intervention. Although there is a higher incidence of pneumothoraces in preterm infants than term, many sick term infants can present with conditions such as meconium aspiration syndrome, hydrops fetalis, chylothorax, lung hypoplasia, and pneumonia that put them at a higher risk for requiring the need for chest tube placements as well. Aly H, et al., The Journal of Maternal-Fetal & Neonatal Medicine. 2014; 27(4):402-406.

Aside from pneumothoraces, other conditions that require the placement of chest tubes include pleural effusions and chylothoraces. Chylothorax is the most common effusion in the newborn period. Depending on the etiology, it is a condition often requiring repetitive drainage with multiple chest tubes.Complications include: malposition, lung impalement/perforation, infection, scarring, bronchopulmonary fistula, hemorrhage, nerve damage, cardiac perforation, and death. Kesieme E B, et al. Pulmonary Medicine. 2012; 2012:256878.

There are more than 1000 Neonatal Intensive Care Unit's (NICU) in United States with approximately 5200 practicing NNP's, and 4200 Neonatologist. There are also Hospitalist, Pediatricians or Physician extenders, all of who provide newborn care at different levels of nurseries and NICU's. Thus, it is important that these providers receive training to recognize and perform the procedure. Adequate training, however, has not been available. Hence, there is a pressing need for adequate training in neonatology. Specifically, chest tube placement in infants, although lifesaving, can have serious complications, including death. Necessary invasive skills can be simulated with task trainers to train health care providers. However, although a spectrum of technology and computerized training can simulate real life situations, there is no task trainer currently available that can provide simulation for neonatal patients for the procedures of thoracotomies with chest tube placement for pneumothorax or pleural effusions.

Hence, there is a need for an anatomically correct and operable training model that can be used to emulate naturally occurring pathophysiological conditions and to train clinicians to effectively treat such conditions. For example, existing training devices do not include a pericardial sac surrounding a heart or lungs that can be filled with fluid and or air which are surrounded by anatomically correct structures such as a plurality of ribs. Hence, existing devices cannot adequately emulate the human (e.g., infant) body to enable a care-giver to adequately train for an invasive procedure.

Embodiments of the present disclosure provide devices and methods that address the above clinical needs.

### SUMMARY OF THE DISCLOSURE

The present disclosure is directed to an anatomically correct model capable of simulating bodily structures, the feel of such structures and the environment surrounding the structures. The anatomical model of the present disclosure overcomes the deficiencies of existing training models, in part through the inclusion of certain physiologically relevant elements that are necessary to simulate the chest cavity of a human, such as an infant. In fact, the use of the disclosed anatomically correct model resulted in over 90% of the users being able to completely and accurately perform a simulated medical procedure.

As such, in one aspect of the present disclosure an anatomically correct model is provided. In certain embodiments, the anatomical model includes a plurality of simulated of bodily structures. In some embodiments, the plurality of simulated bodily structures includes a thorax. In specific embodiments, the thorax can include an internal cavity and a plurality of ribs. In some embodiments, the internal cavity can also include a heart that is operably connected to the model. In certain embodiments, the heart includes a pericardial sac that substantially surrounds the heart. In a specific embodiment, the anatomically correct model of the present disclosure includes a pericardial sac that can be filled with a fluid or other material.

In other embodiments, the plurality of simulated bodily structures includes at least one membranous layer. The membranous layer includes at least one elastomeric layer that covering at least a portion of an anterior aspect of the thorax and a posterior aspect of the thorax. In specific embodiments, the at least one simulated membrane layer includes a skin layer. In some embodiments, the skin layer can be removed and replaced by, for example, affixing or removing the skin layer to a means for connecting the skin layer to an outer surface of the model. In yet another embodiment, the at least one membranous layer includes a skin layer and at least one other layer, such as a muscle layer or a subcutaneous (adipose or tissue) layer. In certain embodiments, the at least one membranous layer includes a skin layer, a subcutaneous layer and a muscle layer.

In some embodiments, the plurality of bodily structures of an anatomical model of the present disclosure includes at least one chamber such as a lung. In some embodiments, the plurality of simulated bodily structures includes two lungs. In another embodiment, the model includes at least one lung that can be illuminated and expanded (inflated or deflated) by a user. In specific embodiments, the at least one lung is located within an internal cavity of the thorax of such model. For example, in some embodiments, the lung includes at least one bronchus that is operably connected to a lung and the lung is also connected to the trachea within the internal cavity of the model, such that the trachea operably connects to at least one bronchus. In other embodiments, the plurality of simulated bodily structures includes at least one chamber, which can be filled with fluid or air to emulate the space surrounding a lung in the internal cavity (e.g., pleural cavity). In other embodiments, the plurality of simulated bodily structures includes at two chambers, each of which are located in the internal cavity of the thorax. In one embodiment, at least one chamber is filled with air to emulate a pneumothorax. In other embodiments, at least one chamber is filled liquid to emulate a pleural effusion.

In another aspect of the present disclosure, a method for using the disclosed anatomical model is provided. In certain embodiments, the anatomically correct model of the present disclosure can be used to simulate chest tube placement in a subject, such as a human. In some embodiments, the methods of the present disclosure include simulations of the timing, preparation, technique and incisions included in the placement of a chest tube. In specific embodiments, the methods of the present disclosure include one or more of the following techniques, making a subcutaneous tract in a subject, perforating a pleural cavity, placement (insertion) of a chest tube in a subject, draining air or fluid from the thorax of a subject, suturing a tube in a subject and providing sterile dressing to affected sites of the subject.

In some embodiments, the anatomically correct model of the present disclosure is used to emulate a subject in need of thoracostomy tube insertion. In one embodiment, an anatomical model of the present disclosure can be used to simulate a subject having a cardiac tamponade. In specific embodiments, the anatomical model can be used to simulate pericardiocentisis in cardiac tamponade from a pericardial effusion or pneumopericardium of a subject. In other embodiments, the anatomical model can be used to simulate pneumothorax in a subject, such as an infant. In certain embodiments, the model can be used to emulate conditions found in a human infant diagnosed with respiratory distress syndrome, meconium aspiration syndrome, hydrops fetalis, chylothorax, lung hypoplasia, and pneumonia.

### BRIEF DESCRIPTION OF THE DRAWINGS

The present disclosure will be better understood by reference to the following drawings, which are provided as illustrative of certain embodiments of the subject application, and not meant to limit the scope of the present disclosure.

FIG. 1 is a photograph of a model of the present disclosure. FIG. 1 depicts an embodiment of the present disclosure including the following bodily structures: a thorax (2), and a plurality of ribs (10), each rib separated by an intercostal space (12). The exemplary model (1) set forth in FIG. 1 also provides a chest tube (11) inserted into an internal cavity by traversing through an intercostal space (12) between two of a plurality of ribs (10).

FIGS. 2A-2B show cross sections of exemplary simulated membranous layers (16) of the present model. FIG. 2A provides a drawing of an exemplary at least one simulated membranous layer (16), which can surround (i.e., cover) the outermost surface of anterior (4) and posterior (6) portions of the thorax (2) of a model (1). The cross section of the exemplary membranous layer (16) shows a membranous layer of the disclosed model that includes three layers (18, 20 and 22). FIG. 2B shows a magnified view of the exemplary simulated membranous layer (16) depicted in FIG. 2A, which includes a dermis (skin) layer (18) that is in direct contact with a subcutaneous (adipose) layer (20), and a muscle layer (22) that is in direct contact with the adipose layer (20).

FIG. 3 shows an exemplary model (1) of the present disclosure that includes a heart (14) contacted by a pericardial sack (15) and located within the internal cavity (8) of the model (1) the disclosed model. The exemplary model shown also includes at least one lung (24) connected to (i.e., operably affixed to) a trachea (26) by a bronchus (28) such that each of the lungs (24) can be inflated or deflated through the bronchus (28) to simulate a physiologically functional lung. The exemplary model also shows two chambers (31), which can be inflated or filled with fluid to emulate tension on the lung (24) and heart (14).

FIG. 4 shows an exterior view of a model of the present disclosure capable of being transilluminated. The exemplary model shown in FIG. 4 provides an anatomical model (1) that includes at least one membranous layer (16) that is located on an outermost surface of a plurality of ribs (10) such that the at least one membranous layer (16) substantially surrounds and encloses the outermost surface of the internal cavity (8) of the model.

FIG. 5 is a photograph of an exemplary model of the present disclosure. The model shown includes the following simulated bodily structures: a plurality of ribs (10), at least one membranous layer (16) that is composed of a skin layer (18) and a subcutaneous membranous layer interposed between the skin layer (18) and the plurality of ribs (10).

FIG. 6 is a top-down view of a portion of a model of the present disclosure. The exemplary model shown includes at least one membranous layer (16) composed of muscle (22) that contacts and surrounds a plurality of ribs (10) and the intercostal spaces (12) located between each rib (10).

FIGS. 7A and 7B show three dimensional images of an exemplary plurality of ribs (10) surrounding an internal cavity (8) with intercostal spaces (12) to form a thorax (2) of a model of the present disclosure.

FIG. 8 shows an exemplary embodiment of an anatomical model of the disclosure. FIG. 8 shows a model including at least one simulated membranous layer (16) composed of an outermost skin layer (18), a subcutaneous layer (20) and a muscle layer (22) through which a subcutaneous tunnel (30) (e.g., thoracostomy tube) can be inserted into the pleural space within an internal cavity of a model (not shown).

FIG. 9 shows a magnified view of the pericardiocentesis being preformed entering the pericardial sac (15) in FIG. 3. In this embodiment the pericardial sac (15) surrounding a heart (14) (not shown) is filled with fluid to emulate cardiac tamponade and is used for training of pericardiocentesis

FIGS. 10A-10B show an exemplary embodiment of an anatomical model of the present disclosure. FIG. 10A shows a support structure (27) including a first angled support (27a) and a second angled support (27b) connected by a topmost angled surface (27c) capable of contacting a surface of the model. FIG. 10B shows a thorax (2) affixed to a support structure (27) such that the thorax (2) has a horizontal topmost surface (2a) and membrane closure elements (e.g., pegs, screws, clips) (32) for the addition or removal of an at least one membranous layer (not shown).

FIGS. 11A-11B provide computer renderings of exemplary models of the present disclosure. FIG. 11A shows a model, such as for a preterm infant (left) and a larger term infant (right) version of the model in transparent or substantially transparent form. FIG. 11B shows a magnified view of the larger model from FIG. 11A. The exemplary model of FIG. 11B shows a thorax (2) including a plurality of ribs (10) surrounding an internal cavity (8) affixed to a support (27).

FIG. 12 shows an exemplary model of the present disclosure that includes the following simulated bodily structures: a thorax (2) that includes a plurality of ribs (10) located within an internal cavity (8) of the thorax (2); a membraneous layer (16) surrounding the internal cavity (8) of the thorax (2) leur lock syringe and tubing to fill chambers (33); and a diaphragm (29) affixed to the distal portion of the plurality of ribs (10).

### DETAILED DESCRIPTION OF THE DISCLOSURE

In the discussion and claims herein, the term “about” indicates that the value listed may be somewhat altered, as long as the alteration does not result in nonconformance of the process or device. For example, for some elements the term “about” can refer to a variation of ±0.1%, for other elements, the term “about” can refer to a variation of ±1% or ±10%, or any point therein.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat.

As used herein terms such as “a”, “an” and “the” are not intended to refer to only a singular entity, but include the general class of which a specific example may be used for illustration.

As used herein, terms defined in the singular are intended to include those terms defined in the plural and vice versa.

References in the specification to “one embodiment”, “certain embodiments”, some embodiments” or “an embodiment”, indicate that the embodiment(s) described may include a particular feature or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. For purposes of the description hereinafter, the terms “upper”, “lower”, “right”, “left”, “vertical”, “horizontal”, “top”, “bottom”, and derivatives thereof shall relate to the invention, as it is oriented in the drawing figures. The terms “overlying”, “atop”, “positioned on” or “positioned atop” means that a first element, is present on a second element, wherein intervening elements interface between the first element and the second element. The term “direct contact” or “attached to” means that a first element, and a second element, are connected without any intermediary element at the interface of the two elements.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

This disclosure is directed to an anatomically correct model that includes a plurality of simulated bodily structures. Each of the plurality of simulated body structures are at least substantially anatomically correct and are each formed of materials that substantially correlate to the natural structure and feel of their corresponding anatomical elements. For example, a skin layer can include a silicon material or mesh or fabric that emulates the feel, structure and consistency of a human dermal layer. In one instance, an adipose layer can be composed of a gelatin having a consistency and thickness that emulates that of a human. Other materials and their corresponding organs or structures, which can be used in the models of the present disclosure, will be known by one of ordinary skill in the art.

The disclosed anatomical model can include several components, including a thorax forming an internal cavity, with a heart, at least one lung and a trachea located within the internal cavity and an at least one membranous layer that substantially covers the exterior surface of the thorax.

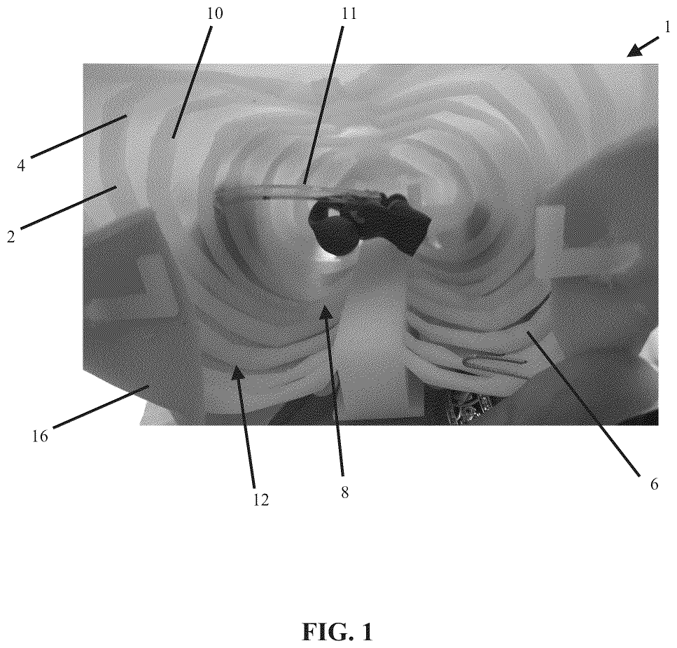

As shown in FIG. 1, in certain embodiments the disclosed anatomical model (1) includes a thorax (2) having an anterior portion (4) and a posterior portion (6). The anterior portion (4) and the posterior portion (6) of the thorax (2) can be composed of any suitable material, such as one or more of plastic, rubber, silicon and carbon based materials. Further, the thorax (2) can be formed though any suitable manufacturing process known by one of ordinary skill in the art, including additive manufacturing (such as three-dimensional (3D) printing, or through the use of a mold specific to the anatomical model).

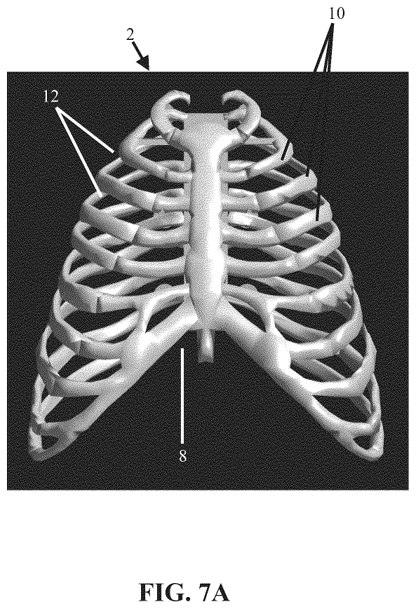

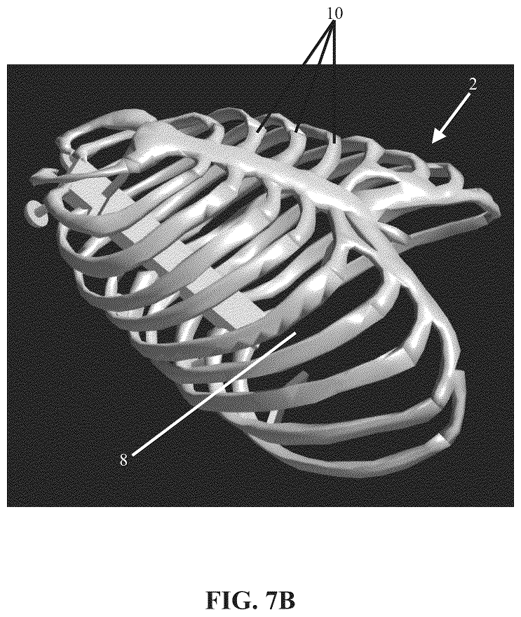

The anterior portion (4) and the posterior portion (6) of the thorax (2) form an internal cavity (8), which can then be surrounded, in whole or in part, by a plurality of ribs (10). As shown in FIG. 1, the plurality of ribs (10) of the model (1) includes intercostal spaces (12) interspersed between adjacent ribs (10). In one embodiment, each of the intercostal spaces (12) can be substantially the width or size (between each adjacent rib). In other embodiments, each of the intercostal spaces (12) can have different widths or sizes (between each adjacent rib). In a specific embodiment, the intercostal spaces (12) between each of a plurality of ribs (10) has a size (height and width) that corresponds to the intercostal spaces found between adjacent ribs on an infant human. See FIGS. 7A and 7B showing three dimensional images of an exemplary plurality of ribs (10) surrounding an internal cavity (8) to form a thorax (2) of a model of the present disclosure.

For example, the intercostal spaces (12) between each of a plurality of ribs (10) are substantially the same size as those found in an infant human, which has a weight of about 0.5 kg to about 3.5 kg, from about 1 kg to about 3.5 kg. Also, the skeletal structure of the model 1 can be substantially the same as the chest wall diameter and length of the thorax of an infant human which is between the weights of about 0.5 kg and about 3.5 kg. In some embodiments, the size of the human infant that is being emulated by the present model is an infant having a weight of between 0.5 kg to 3.5 kg, 1.0 kg to 3.5 kg, 0.5 kg to 3.0 kg, 1.0 kg to 3.0 kg, 0.5 kg to 2.5 kg, 1.0 kg to 2.5 kg, 0.5 kg to 2.0 kg, 1.0 kg to 2.0 kg, 0.5 kg to 1.5 kg, or 0.5 kg to 1.0 kg. In other embodiments, the size of the human infant that is being emulated by the present model is an infant having a weight of about 0.5 kg, 0.6 kg, 0.7 kg, 0.8 kg, 0.9 kg, 1.0 kg, 1.1 kg, 1.2 kg, 1.3 kg, 1.4 kg, 1.5 kg, 1.6 kg, 1.7 kg, 1.8 kg, 1.9 kg, 2.0 kg, 2.1 kg, 2.2 kg, 2.3 kg, 2.4 kg, 2.5 kg, 2.6 kg, 2.7 kg, 2.8 kg, 2.9 kg, 3.0 kg, 3.1 kg, 3.2 kg, 3.3 kg, 3.4 kg, or 3.5 kg. Thus, the anatomically correct model (1) of the present disclosure can be of a structure that imitates a human infant's skeletal and organ structure and can be used for training procedures on human infant medical procedures. For example, and as shown in the exemplary embodiment set forth in FIG. 1, a chest tube (11) is shown after insertion into the internal cavity of the model (8) by traversing the intercostals space (12) located between two adjacent ribs (10).

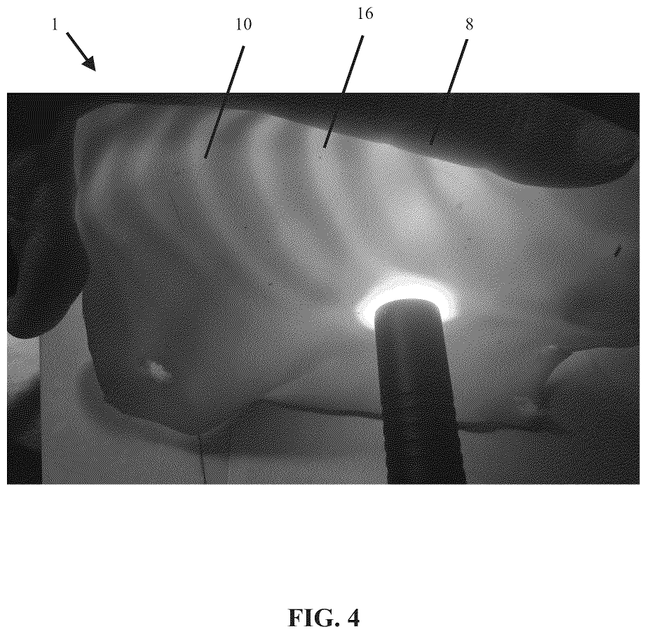

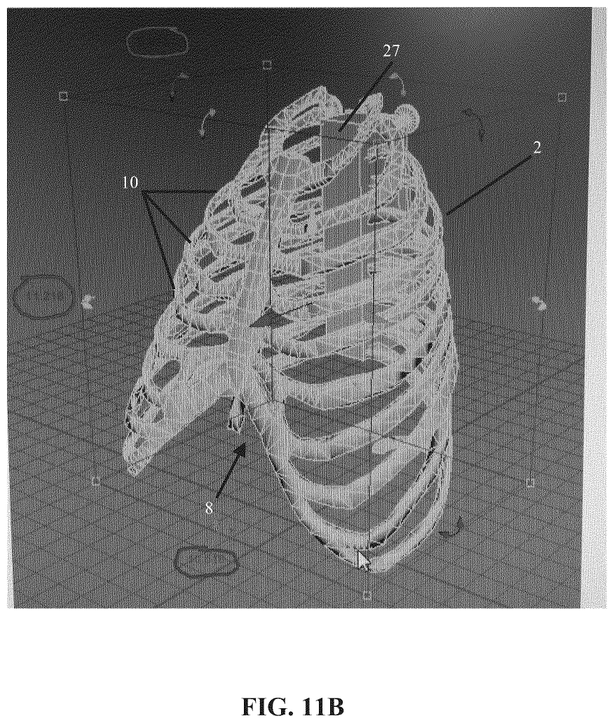

Further, as shown in FIG. 11A a model of the present disclosure, such as for a preterm infant (left) and a larger term infant (right) version of the model can include ribs (10) that are transparent or substantially transparent, such that the ribs permit the passing of light into the internal cavity (8) of the model. This enables the user to emulate and detect pneumothorax in the model without the costly and timely use of x-rays, through transillumination (FIG. 4) of the model.

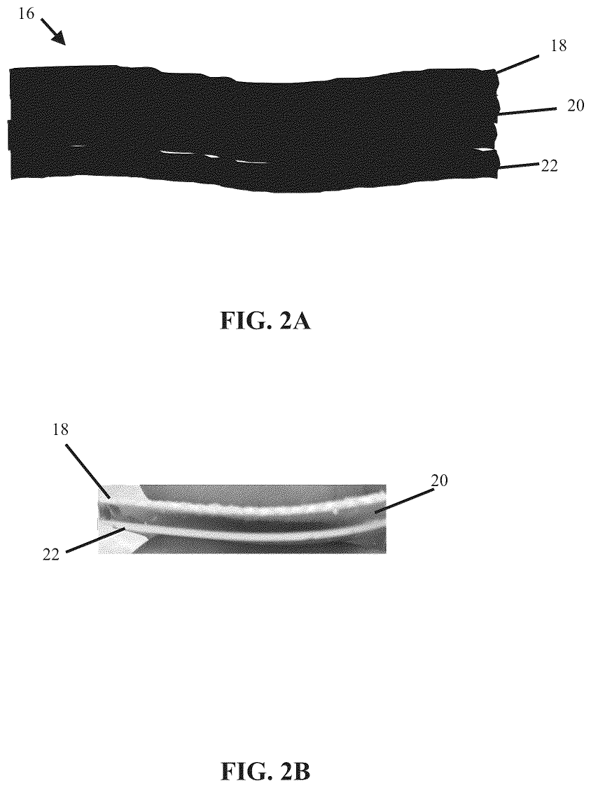

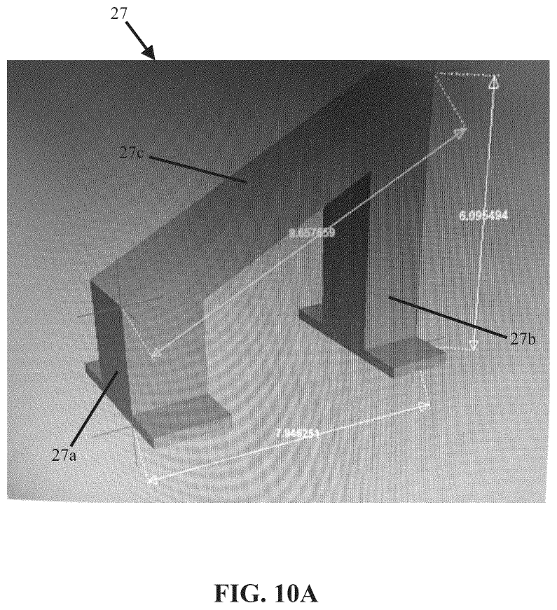

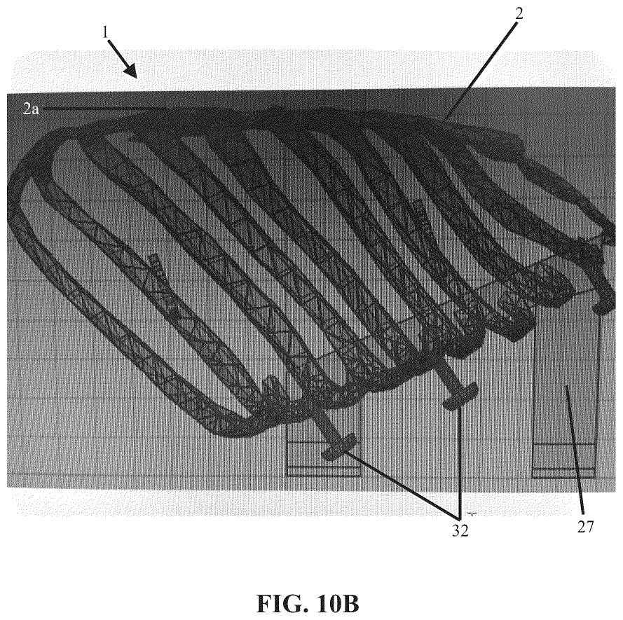

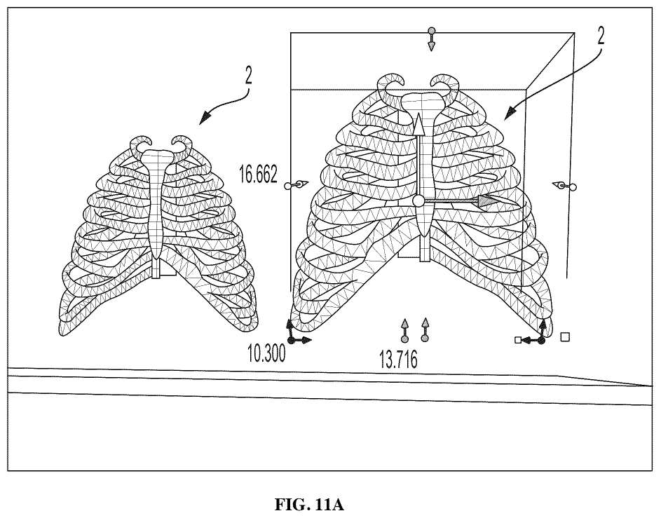

As shown in FIGS. 2A and 2B, the anatomically correct model (1) of the present disclosure can include at least one simulated membranous layer (16). In certain embodiments, the at least one membranous layer (16) substantially covers the outermost surface of the thorax (2), i.e, from the anterior portion of the thorax (4) to the posterior portion of the thorax (6). In some embodiments, the at least one membranous layer (16) is affixed to the thorax (2) in desired position by any suitable mechanical element (such as, for example, a button and slot, a clamp, a hole fitting over a post on the thorax, etc.) or any suitable adhesive capable of affixing two adjacent elements. For example, the at least one membranous layer (16) can be affixed to the outermost surface of the thorax (2) of the model (1) by a pin, clamp, screw, button, Velcro, a peg or a clip. See FIG. 10B showing a model (1) that includes membrane closure elements (e.g., pegs, screws, clips) (32) for the addition or removal of an at least one membranous layer (16).

In the specific embodiment, exemplified in FIG. 1, the at least one membranous layer (16) is mechanically maintained (affixed) in position and can be removed and replaced with another membranous layer (16). In certain embodiments, the at least one membranous layer (16) comprises at least one elastomeric layer of a single elastomer or a mixture of elastomers, such as, any suitable rubber and plastic material.

In one embodiment, the at least one membranous layer (16) includes at least two layers or at least three layers. In certain embodiments, the at least one membranous layer (16) includes a skin layer (18), which is composed of a silicon material in a manner that mimics the elasticity, structure and density of the human dermis. In other embodiments, the at least one membranous layer (16) includes a subcutaneous layer (20) composed of a gel and/or silicon that emulates the density, elasticity and structure of human fat (adipose) and/or subcutaneous tissue. In certain embodiments, the anatomically correct model (1) of the present disclosure includes a muscle layer (22) that emulates the density, elasticity and structure of human muscle tissue. In specific embodiments, the model of the present disclosure includes an at least one membranous layer (16) having a skin layer (18) and a subcutaneous layer containing one or more of an adipose layer (20) and/or one or more of a subcutaneous tissue layer. In some embodiments, of the present disclosure the anatomically correct model (1) has an at least one membranous layer (16) that includes a skin layer (18) and a subcutaneous layer containing an adipose layer (20) and a muscle layer (22). See, for example, FIG. 2A and FIG. 2B.

In some embodiments, the skin layer (18) can be adhered to the topmost surface of the subcutaneous layer (e.g., adipose layer (20)) or a muscle layer (22). In instances where the anatomically correct model (1) has a membranous layer (16) that includes a skin layer (18) and a subcutaneous layer containing an adipose layer (20) and a muscle layer (22), the skin layer (18) is adhered to the topmost surface of the subcutaneous layer (20). For example, the skin layer (18) is adhered to the topmost surface of the adipose layer (20), and the bottommost surface of the adipose layer (20) is adhered to a topmost surface of a muscle layer (22), which is then adhered to the outermost surface of the thorax (2). One example of how the at least one membranous layer (16) of the present disclosure is formed is discussed in Example 1, below.

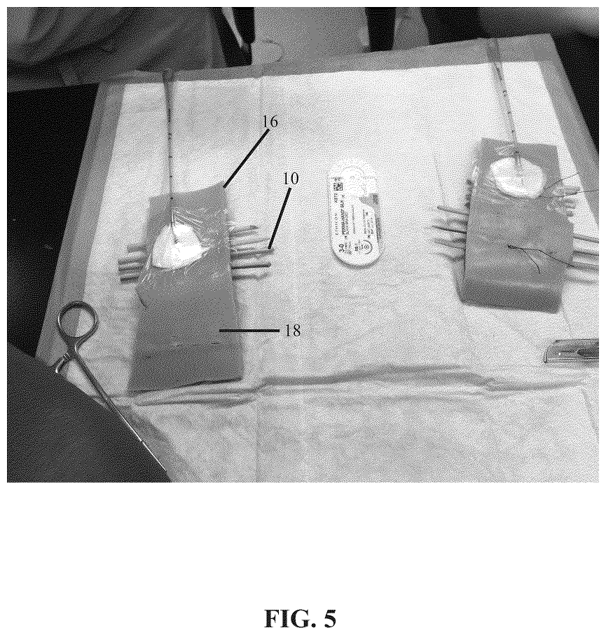

In other embodiments, such as that shown in FIG. 5, the anatomically correct model (1) has an at least one membranous layer (16) that includes a skin layer (18) and a subcutaneous layer containing an adipose layer (20). In this embodiment, the skin layer (18) can be adhered to the topmost surface of the subcutaneous layer (e.g., adipose layer (20)) and the opposing surface of the subcutaneous layer is affixed to an outermost surface of a plurality of ribs (10) and the intercostals spaces (12) located between adjacent ribs (10).

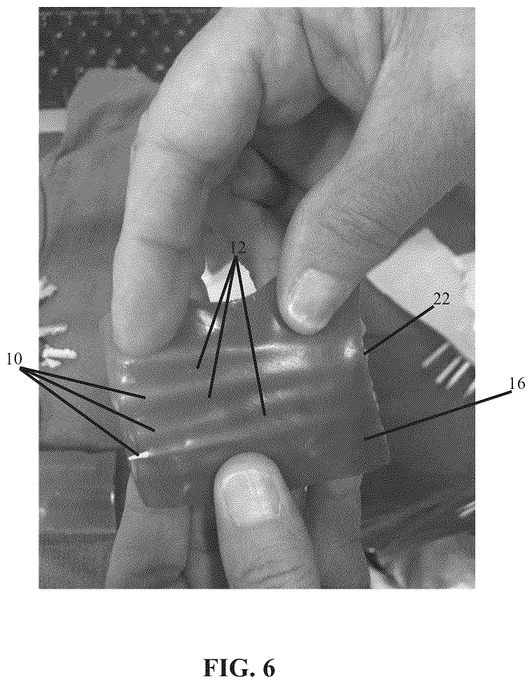

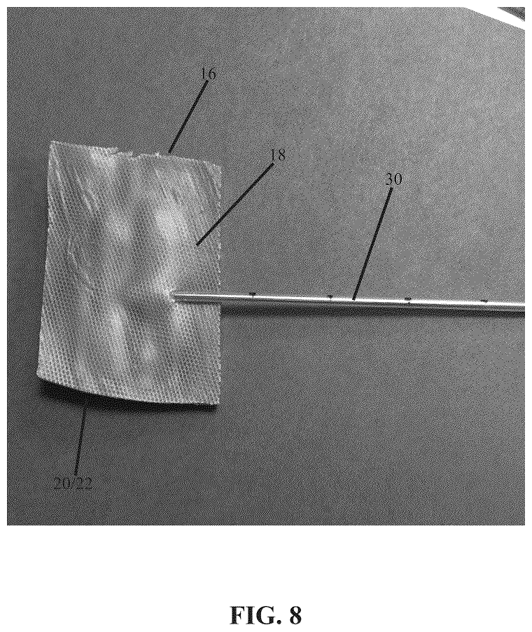

In embodiments of the disclosed model, such as that shown in FIG. 6, the anatomically correct model (1) has an at least one membranous layer (16) that includes a skin layer (18) and a muscle layer (22). In this embodiment, the skin layer (18) can be adhered to the topmost surface of the muscle layer (22) and the opposing surface of the muscle layer is affixed to an outermost surface of a plurality of ribs (10) and the intercostals spaces (12) located between adjacent ribs (10). For example, as shown in FIG. 8, the model (1) can have an at least one simulated membranous layer (16) composed of an outermost skin layer (18) and a separate and distinct simulated membranous layer including a muscle layer (22) through which a subcutaneous tunnel (30) (e.g., thoracostomy tube) can be inserted and traverse into the pleural cavity.

The various embodiments of the present disclosure that include subcutaneous layers comprising different material layers, enable a user to practice medical techniques including, but not limited to, those that include traversing the at least one needle layer, with a tube or needle. For example, needle aspiration through membranous layer (16) for pneumothorax relief; needle aspiration through membranous layer (16) for a pleural effusion treatment; chest tube placement through intercostal spaces (12) including simulation of injection of an analgesic (e.g. lidocaine) or anesthetic into the membranous layer (16); incising the membranous layer (16) to create a subcutaneous tract and/or tunnel in the membranous layer (16) into the pleural cavity; maneuvering of the a tube anteriorly or posteriorly in the internal cavity (8); suturing a chest tube to the membranous layer (16); and applying appropriate dressing to the exposed surface of a membranous layer (16).

Although not shown to scale in FIG. 2A, the skin layer (18) and the muscle layer (22) can be about 1 mm thick and the adipose layer (20) can be up to about 5 mm thick to mimic the density, elasticity and structure of human dermis and subcutaneous tissue. See FIG. 2B. In other embodiments, the adipose layer (20) is between 0.5 mm and 5.0 mm thick. In yet other embodiments, the adipose layer (20) is between 0.5 mm and 1.0 mm, 0.5 and 1.5 mm, 0.5 and 2.0 mm, 0.5 and 2.5 mm, 0.5 and 3.0 mm, 0.5 and 3.5 mm, 0.5 and 4.0 mm, or 0.5 and 4.5 mm thick. In certain embodiments, the adipose layer (20) is about 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 3.1 mm, 3.2 mm, 3.3 mm, 3.4 mm, 3.5 mm, 3.7 mm, 3.8 mm, 3.9 mm, 4.0 mm, 4.1 mm, 4.2 mm, 4.3 mm, 4.4 mm, 4.5 mm, 4.6 mm, 4.7 mm, 4.8 mm, 4.9 mm or 5.0 mm.

In some embodiments, the skin layer (18) is between 0.5 mm and 1.5 mm thick. In yet other embodiments, the skin layer (18) is between 0.75 mm and 1.25 mm, 0.75 and 1.0 mm, or 0.5 and 1.0 mm thick. In certain embodiments, the skin layer (18) is about 0.5 mm, 0.6 mm, 0.7 mm, 0.8 mm, 0.9 mm or about 1.0 mm thick. The foregoing skin layer thicknesses are important to emulate the thickness, density and elasticity of the human dermis.

In some embodiments, the muscle layer (22) is between 0.5 mm and 1.5 mm thick. In yet other embodiments, the muscle layer (22) is between 0.75 mm and 1.25 mm, 0.75 and 1.0 mm, or 0.5 and 1.0 mm thick. In certain embodiments, the muscle layer (22) is about 0.5 mm, 0.6 mm, 0.7 mm, 0.8 mm, 0.9 mm or about 1.0 mm thick. The foregoing muscle layer thickness are important to emulate the thickness, density and elasticity of human muscle tissue, specifically that of an infant.

In certain embodiments, the subcutaneous layer contains an adipose layer (20) that can be can be formed in a manner and location that allows for a simulated subcutaneous tunnel or tract to be formed traversing the layer. This tunnel or tract provides a means for inserting a chest tube through the muscle layer (22) into the internal cavity (8) of the model (1) by an operator.

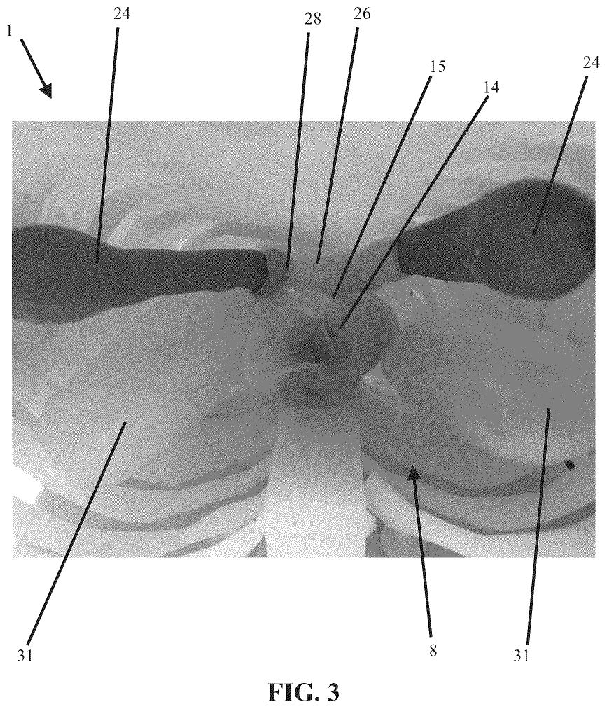

Referring to FIG. 3, the disclosed anatomically correct model includes at least one lung (24) located within the internal cavity (8). In some embodiments, the at least one lung is affixed to a trachea (26) at one end and a bronchus (28) at the opposite end. In certain embodiments, such as that exemplified in FIG. 3, the model (1) includes two lungs (24) that are operably connected to a trachea and a bronchus (28), such that each of the lungs (24) can be inflated or deflated through the bronchus (28) operably attached thereto. In the embodiment illustrated in FIG. 3, each of the lungs (24) is in a substantially deflated state.

In other embodiments and as shown in FIG. 3, the plurality of simulated bodily structures includes at least one chamber (31), which can be filled with fluid or air to emulate the space surrounding a lung (14) in the internal cavity (8) (i.e., a pleural cavity). For example, a chamber (31) can encapsulate the lung (24), emulating the parietal pleura of an infant. In some embodiments, the plurality of simulated bodily structures includes at two chambers (31), each of which are located in the internal cavity (8) of the thorax (2). In one embodiment, at least one chamber is filled with air to emulate a pneumothorax. In other embodiments, at least one chamber is filled liquid to emulate a pleural effusion.

As seen in FIG. 3, included in certain embodiments of the disclosed anatomically correct model is a heart (14), located within the internal cavity (8), which is removable and operably connected to the model (1) at, for example the thorax (2). In FIG. 1, the heart is not shown. As shown in the exemplary embodiment of FIG. 3, the heart (14) is entirely within the internal cavity (8) of the thorax (2) and is substantially surrounded by a pericardial sac (15). In this embodiment of the model (1) the heart (14) is formed of a substantially solid material, such as a foam or clay, and the pericardial sac (15) is formed of an expandable elastomer material such as a condom or balloon. In other embodiments, the pericardial sac (15) is made of a gelatin or silicon material capable of holding a pressurized gas or liquid between the outermost surface of the heart (14) and the inner most surface of the pericardial sac (15).

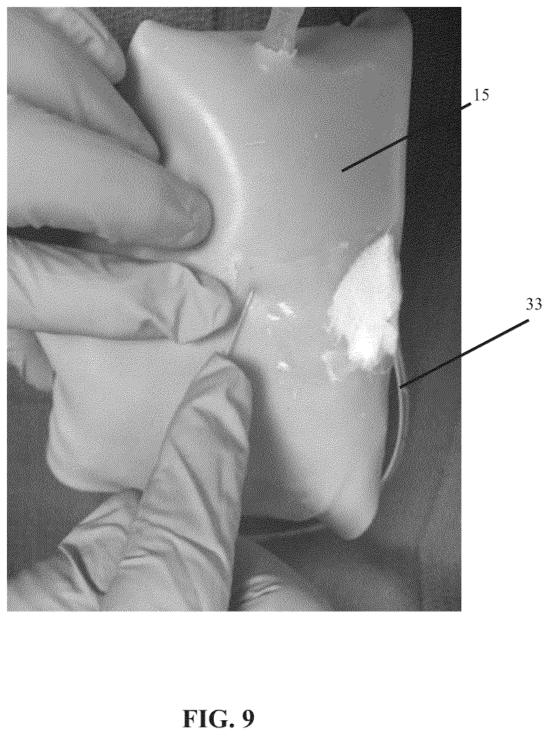

For example, as shown in FIG. 9, the pericardial sack (15) is configured to contain a pressurized gas and/or a fluid in a space formed between the pericardial sac (15) and the heart (14) by methods known to those of ordinary skill in the art. In this instance, the pressurized gas and/or fluid enters the space between the pericardial sac (15) and the underlying heart (14) through tubing (33), such as a luer lock syringe and tubing, formed in the surface of either of the pericardial sac (15) or the heart (14). To simulate an occurrence of a tamponade, the pericardial sac (15) can contain a suitable fluid known by those of ordinary skill in the art, such that a pericardiocentesis procedure can be simulated by a user.

As shown in FIG. 4, simulated membranous layer (16) can be configured to allow for visualization of the underlying ribs (10) and lungs (24) (not shown). In the exemplary embodiment depicted in FIG. 4, a flashlight is placed on or near the surface of membranous layer (16) to show the translucent nature of the simulated membranous layer. However, illumination may be provided by other means such as by the implantation of small light-emitting diodes (LEDs) or other small bulbs affixed to the model in a manner that illuminates the internal cavity (8) of the model. Illumination enables, for example, identification of a pneumothorax condition in the model, and thus provides a means for simulating diagnosis and treatment thereof by the user. In certain embodiments, the simulated membranous layer (16) can also be configured to allow for palpation of the underlying ribs (10) by an operator, which permits the user to compress the chest of the model and evaluate the breathing pattern of the model.

Moving to FIGS. 10A and 10B, the model (1) of the present disclosure can include a support structure (27). The support structure (27) can be made of any material capable of supporting the model (1), such as plastics (e.g., polyvinyl chloride (PVC), high-density polyethylene (HDPE), polypropylene (PP) or polystyrene (PS), metals (e.g., steel, aluminum or titanium) or other composites (e.g., carbon fiber). In such embodiments, the support structure (27) includes a first angled support (27a) and a second angled support (27b) connected by a topmost angled surface (27c) capable of contacting a surface of the model. When such a support structure (27) is affixed to the model (1) the thorax (2) has and maintains a horizontal topmost surface (2a) that emulates the angle that a subject (e.g., human infant) would present while lying down. See FIG. 10B.

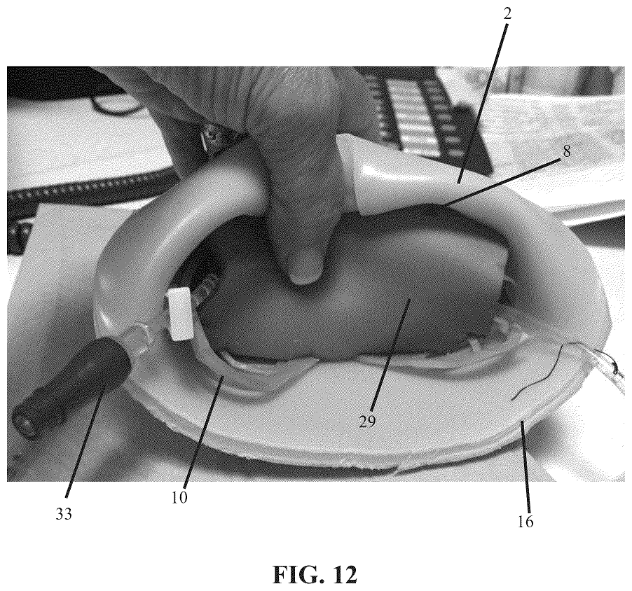

In one embodiment, the anatomically correct model (1) of the present disclosure includes a simulated diaphragm (29), as shown in FIG. 12. In certain embodiments, the diaphragm (29) located within the internal cavity (8) of the model (1). In this instance, the diaphragm (29) is capable of inflation and deflation by an operator through the use of, for example, a leur lock syringe and tubing (33) that permits the flow of air into or out of the diaphragm (29). As shown in the exemplary model depicted in FIG. 12, the diaphragm (29) is located within the thorax (2) and is affixed to the distal portion of a plurality of ribs (10).

### METHODS

As set forth above, the model (1) of the present disclosure can be used to practice several medical interventions and procedures on an anatomically correct device that emulates the real life clinical conditions faced by clinicians. More specifically, using the disclosed model, operators will be able to simulate the methodology for, amongst other actions, proper chest tube placement.

As such, in certain aspects of the present disclosure, a method for using the disclosed model for simulations of, for example, preparation, time out, sterile technique, incision, making a subcutaneous tract, perforating into pleural space, placement of a chest tube, draining air or fluid, suturing the chest tube and dressing the site. The disclosed model can also be used to simulate pericardiocentesis in cardiac tamponade or pneumopericardium.

For example, the anatomically correct model of the present disclosure can be used to practice the follwing procedures: positive pressure ventilation (PPV) with lung (24) inflation (see FIG. 3; chest compressions of thorax (2) (see FIG. 12); identification of true anatomical landmarks of intercostal spaces (12) (see FIGS. 3-4 and 6); needle aspiration through membranous layer (16, 20, 22) for pneumothorax relief (see FIG. 5); needle aspiration through membranous layer (16, 20, 22) for a pleural effusion (see FIG. 5); pericardiocentesis of the pericardium (15) (see FIG. 9); chest tube placement through an intercostal space (12) including simulation of injection of an analgesic (e.g. lidocaine) or anesthetic into the membranous layer (16) (see FIGS. 4 and 8); incising the membranous layer (16), creating a subcutaneous tract and/or tunnel in the membranous layer (20/22) (see FIGS. 1 and 8), palpating the superior portion of a rib (10) (see FIG. 12); maneuvering of a chest tube anteriorly or posteriorly in the internal cavity (8) (see FIG. 1), suturing the chest tube to the membranous layer (16) and applying appropriate dressing to the membranous layer (16). See FIG. 8.

The methods and model of the present disclosure will be better understood by reference to the following Examples, which are provided as exemplary of the disclosure and not in any way limiting.

### Example 1

An anatomically correct simulated membranous layer (16) of the present disclosure was fabricated using commercially available products from Smooth-On, Inc. ™. The skin layer (18) was made using Ecoflex® 00-30, a platinum catalyzed silicone. The silicone material layer was brushed into a mesh fabric and allowed to cure. See FIG. 8. In embodiments, where the simulated membraneous layer (16) includes an subcutaneous layer (20), the subcutaneous adipose layer (20) was formed using Ecoflex® Gel. Ecoflex® Gel is also a silicone product, but it is softer than the skin layer (18), and thus allows for creation of a subcutaneous tract having a density that emulates that of the physiological dermal and underlying subcutaneous tissue. To form the adipose layer, Ecoflex® Gel was poured directly over a skin layer (18) and scraped to form a layer about 3 mm in thickness on a surface of the skin layer (18). See FIG. 2B. The adipose material layer was then allowed to cure. In instances when the simulated membranous layer (16) includes a muscle layer (22) the muscle layer is formed by pouring Ecoflex® 00-30 directly over the skin (18) or adipose layer (20). The muscle material layer is then brushed to a thickness of about 1 mm and cured.

When creating skin for a larger subject such as a full term neonatal infant (3.5 kg in weight), a second adipose layer (20a) can be formed on the topmost surface of the first adipose layer (20) as described above.

This membranous layers (16, 20, 22) then is of such a structure, density and elasticity so as to simulate at least one naturally occurring physical characteristic that can be sensed by an operator performing a procedure on a human person. For example, the “pop” and tension felt by an operator of the model when inserting a chest tube through the membranous layer (22) simulates the same process conducted in a human subject.

### Example 2

One model of the present disclosure is formed to include anatomically correct skin (18) and subcutaneous tissue (20) affixed to an underlying plurality of ribs (10). Here the model includes an anatomically correct rib cage and intercostals spaces (12), based on actual clinical measurements of both 1.0-1.5 kilogram (kg) and 3.0-3.5 kg human infant subjects. The ribs (10) and additional elements of the thorax are fabricated with resin by additive manufacturing using 3D printing methods. This creates a precise and anatomically correct model, such as that shown in FIGS. 7A-7B, 11A-11B and 12.

The rib cage of the model is then wrapped in a constructed translucent membranous layer (16) including a skin layer (18), which is tightly secured to pegs (not shown). This permits the visualization and palpation of the ribs, which aids in identifying the placement for thoracostomy tubes. See FIG. 4.

The model also includes space occupying chambers (31) for air and fluid (e.g., balloon or condom), which are important for training clinician to properly insert a chest tube in a subject. See FIG. 3. In this instance, each chamber (31) can be filled with either air to emulate a pneumothorax or with fluid to emulate a pleural effusion of the lung.

Also, a pericardial sac (15) is created surrounding a foam/clay shaped heart located in the internal cavity (8) of the thorax using a latex balloon (e.g., condom) that is capable of being filled with a fluid or gas. See FIG. 3. The sac (15) can be fluid filled (tamponade) to facilitate pericardiocentesis to enable a user to practice, for example, needle aspiration of the fluid, as shown in FIG. 9.

### Example 3

A model affixed to an angled support (27) was created and tested, as shown in FIGS. 10A-11B. The use of the angled support achieved a substantially level chest surface of the model and provided stability for the performance of procedures. Here, the first (27a) and second angled supports (27b) were formed such that an angle was created that prevents tipping of the model when affixed, while maintain a level uppermost surface of the thorax (2a). The angled support also enables access to skin closure pegs (32) that affix a membranous layer to the outermost surface of the thorax (2). See FIG. 10B. This facilitates easy removal and application of additional simulated membranous layers to the model.

### Example 4

A model that includes a diaphragm (29) located within the internal cavity (8) of the thorax (2) as formed and tested. See FIG. 12. Here, an expandable plastic sac was used to simulate a diaphragm (29) and secured to the distal surface of the thorax using, for example, plastic ties. The diaphragm (29) was then secured to create upward pressure into the internal cavity (8) of the model. This upward pressure acts to prevent the installed fluid filled sacs (e.g., lungs, pericardial sacks) from moving during procedures and further emulates the movements of a breathing subject.

The described embodiments and examples of the present disclosure are intended to be illustrative rather than restrictive, and are not intended to represent every embodiment or example of the present disclosure. While the fundamental novel features of the disclosure as applied to various specific embodiments thereof have been shown, described and pointed out, it will also be understood that various omissions, substitutions and changes in the form and details of the devices illustrated and in their operation, may be made by those skilled in the art without departing from the spirit of the disclosure. For example, it is expressly intended that all combinations of those elements and/or method steps which perform substantially the same function in substantially the same way to achieve the same results are within the scope of the disclosure. Moreover, it should be recognized that structures and/or elements and/or method steps shown and/or described in connection with any disclosed form or embodiment of the disclosure may be incorporated in any other disclosed or described or suggested form or embodiment as a general matter of design choice. Further, various modifications and variations can be made without departing from the spirit or scope of the disclosure as set forth in the following claims both literally and in equivalents recognized in law.

1-25. (canceled)

26. A support structure for an anatomical model comprising:
a first support having a first support upper end, a first support lower end, and a first length;
a second support having a second support upper end, a second support lower end, and a second length, the second length greater than the first length; and
a top surface connecting the first support upper end and the second support upper end, the top surface configured to affix thereto an anatomical model.

27. The support structure of claim 26 wherein the first support end, and the second support end, are each angled to the same degree.

28. The support structure of claim 26 wherein the first support lower end and the second support lower end are each comprise a foot to provide-substantially prevent tipping over.

29. The support structure of claim 28 wherein each foot respectively comprises a portion extending outwardly from the first support lower end and from the second support lower end.

30. The support structure of claim 26 wherein the ratio of the length of the top surface to the second length is about 1.4.

31. The support structure of claim 26 wherein the distance between the first support and the second support is about 8 feet.

32. The support structure of claim 26 wherein the ratio of the distance between the first support and the second support to the second length is about 1.3.

33. The support structure of claim 26 wherein the anatomical model comprises a thorax and the thorax is affixed to the top surface.

34. The support structure of claim 33 wherein the thorax has a topmost surface that is maintained in a horizontal position by the support structure.

35. The support structure of claim 34 wherein the horizontal position of the topmost surface of the thorax emulates the angle that a human subject would present when lying down.

36. The support structure of claim 35 wherein the human subject is an infant.

37. The support structure of claim 26 wherein the first support, the second support, and the top surface are comprised of plastic, metal, or composite.

38. The support structure of claim 37 wherein the plastic comprises polyvinyl chloride (PVC), high density polyethylene (HDPE), polypropylene (PP), or polystyrene (PS); the metal comprises steel, aluminum, or titanium; and the composite comprises carbon fiber.

39. The support structure of claim 33 wherein the thorax comprises a skin membrane and thorax skin membrane closure elements; and wherein the support structure is configured to lift the thorax skin membrane closure elements from top surface to permit removal of at least part of the thorax skin membrane.

40. The support structure of claim 39 wherein the thorax skin membrane closure elements comprise pegs, screws, or clips.

41. The support structure of claim 26 wherein the anatomical model affixed to the support structure comprises:
a thorax comprising an internal cavity, an outermost surface, a plurality of ribs having intercostal spaces therebetween;
at least one membranous layer affixed to the outermost layer of the thorax;
a heart within the internal cavity comprising a pericardial sac;
at least one lung within the internal cavity; and
a trachea within the internal cavity.

42. The support structure of claim 41 wherein the anatomical model affixed to the support structure is configured for use in training the following procedures:
positive pressure ventilation (PPV) with lung inflation;
identification of true anatomical landmarks of the intercostal spaces;
needle aspiration through the membranous layer for pneumothorax relief;
needle aspiration through the membranous layer for a pleural effusion;
pericardiocentesis of the pericardium (IS);
chest tube placement through an intercostal space;
simulation of an injection of an analgesic or anesthetic into the membranous layer;
incising the membranous layer;
creating a subcutaneous tract and/or tunnel in the membranous layer;
palpating the superior portion of a rib;
maneuvering of a chest tube anteriorly or posteriorly in the internal cavity;
suturing the chest tube to the membranous layer; or
applying appropriate dressing to the membranous layer.

43. The support structure of claim 26 wherein the anatomical model comprises an internal cavity; and the support structure comprises, in combination, illumination means for illuminating the internal cavity of the anatomical model, the illumination means placed on the anatomical model, near the anatomical model, or inside the anatomical model.

44. The support structure of claim 43 wherein the illumination means comprises a flashlight, light emitting diodes (LEDs), or other light-emitting bulbs.

45. The support structure of claim 43 wherein the anatomical model comprises: a thorax comprising the internal cavity, an outermost surface, and a plurality of ribs having intercostal spaces therebetween;
at least one membranous layer affixed to the outermost layer of the thorax; and
at least one lung within the internal cavity, wherein the plurality of ribs, the at least one membranous layer, or the at least one lung, are translucent.

46. The support structure of claim 43 wherein the illumination means are inside the internal cavity or are affixed to the anatomical model.
